(19) United States
(12) Patent Application Publication
(10) Pub. No.: US 2006/0242867 A1
(43) Pub. Date: Nov. 2, 2006

(54) Advertising apparatus using half-mirror

(76) Inventor: Jong Weon Choi, Seoul (KR)

Correspondence Address: LITMAN LAW OFFICES, LTD, PO BOX 15035, CRYSTAL CITY STATION, ARLINGTON, VA, 22215, US

(21) Appl. No.: 11/117,609

(22) Filed: Apr. 29, 2005

(51) Int. Cl. G09F 13/12

(52) U.S. Cl. 40/219

(57) ABSTRACT

The advertising apparatus using half-mirror is an apparatus having a half-mirror, an advertising print located behind the half-mirror, a lamp unit located behind the advertising print, a frame member enclosing both the half-mirror and the lamp unit, a sensor located in the frame member and controlling operation of the lamp unit, and a power supply linked to the lamp unit and the sensor. The apparatus controls the display of advertising images through a back light with low power consumption and high brightness through use of the half-mirror and the sensor.

### BACKGROUND OF THE INVENTION

1. Field of the Invention

The present invention relates to an advertising apparatus, and more particularly, to an advertising apparatus using a half-mirror that controls advertisement functions automatically and has uniform brightness.

2. Description of the Related Art

Generally, the term advertisement means a commercial or non-profit public announcement in a newspaper, on television, or on a poster about something, such as a product, event, or job, by writing, painting, sound, or other form of communication.

As technology has been advanced, an advertisement means using a half-mirror has been developed recently. The half-mirror (sometimes referred to as a transparent mirror, a two-way mirror, a one-way mirror, etc.) is plate-type material that has the property of being able to show paintings or letters on shining a light from the rear of the plate, so that it is transparent, like glass, and of reflecting the light in the absence of a bright light in the rear of the plate, so that the plate behaves like a mirror.

Such an advertising apparatus using a half-mirror has a rear lighting device, which uses a hot cathode fluorescent lamp, and therefore exhibits relatively low brightness relative to the consumption of electric power as compared to other lighting devices.

Also, since the rear lighting device is formed in the advertising apparatus, the advertising apparatus is increased in size rearwardly, and a large space is required for installing a conventional advertising apparatus using a half-mirror, which adversely affects the appearance of the advertising space.

Thus, the advertising apparatus using a half-mirror according to the present invention solving the aforementioned problems is desired.

### SUMMARY OF THE INVENTION

The advertising apparatus includes a half-mirror; an advertising print located behind the half-mirror; a lamp unit located behind the advertising print; a frame member enclosing both the half-mirror and the lamp unit; and a sensor located in the frame member and controlling operation of the lamp unit. The advertising print is a light permeable panel. The lamp unit includes at least one lamp, a light guide panel located behind the advertising panel, a lamp housing connected to one end or edge of the light guide panel, and a reflective panel located behind the light guide panel. The light guide panel has a plurality of scattering fragments for adjusting light scattering angles, and the reflective panel forms a plane mirror for reflecting light from the lamp. The apparatus acts as an ordinary mirror with the lamp off, but displays an advertising print when the sensor detects a person approaching.

Preferably, the lamp comprises a cold cathode fluorescent lamp. The sensor may be an optical sensor, an infrared sensor, or an ultrasonic sensor. Preferably, the sensor is located in the front of the frame member and senses the presence of a consumer or patron approaching the advertising apparatus to turn on the lamp unit and activate the advertising display. The apparatus includes a power supply linked to the lamp unit and the sensor. The power supply includes a controller for supplying electrical power, and may include an inverter when the power supply includes a battery for supplying a.c.

The combination of the cold cathode lamp with the light guide panel and the reflector panel provides the advertising apparatus with a rear lighting device that consumes relatively lower electrical power, but provides high brightness for exhibiting the advertising print. The construction and arrangement of parts in the lamp unit provides for a more compact volume than conventional advertising apparatus with half-mirrors. The sensor provides for automatic operation of the advertising apparatus, and may dramatically decrease the consumption of power by turning the apparatus off until a person approaches the apparatus.

These and other features of the present invention will become readily apparent upon further review of the following specification and drawings.

### BRIEF DESCRIPTION OF THE DRAWINGS

FIG. 1 is an exploded top view diagrammatically showing the arrangement of components in an advertising apparatus using half-mirror according to the present invention.

FIG. 2 is an exploded perspective view showing an advertising apparatus with half-mirror according to the present invention.

FIGS. 3A to 3C show a diagrammatic front view of a light guide panel of the advertising apparatus of the present invention, and particularly the density distribution of scattering fragments in the panel for a single lamp, a lamp on opposite sides of the panel, and lamps on all four sides of the panel, respectively.

FIG. 4 is a diagrammatic top view of an embodiment of a light guide panel according to the present invention.

Similar reference characters denote corresponding features consistently throughout the attached drawings.

### DETAILED DESCRIPTION OF THE PREFERRED EMBODIMENTS

The present invention is an advertising apparatus with half-mirror.

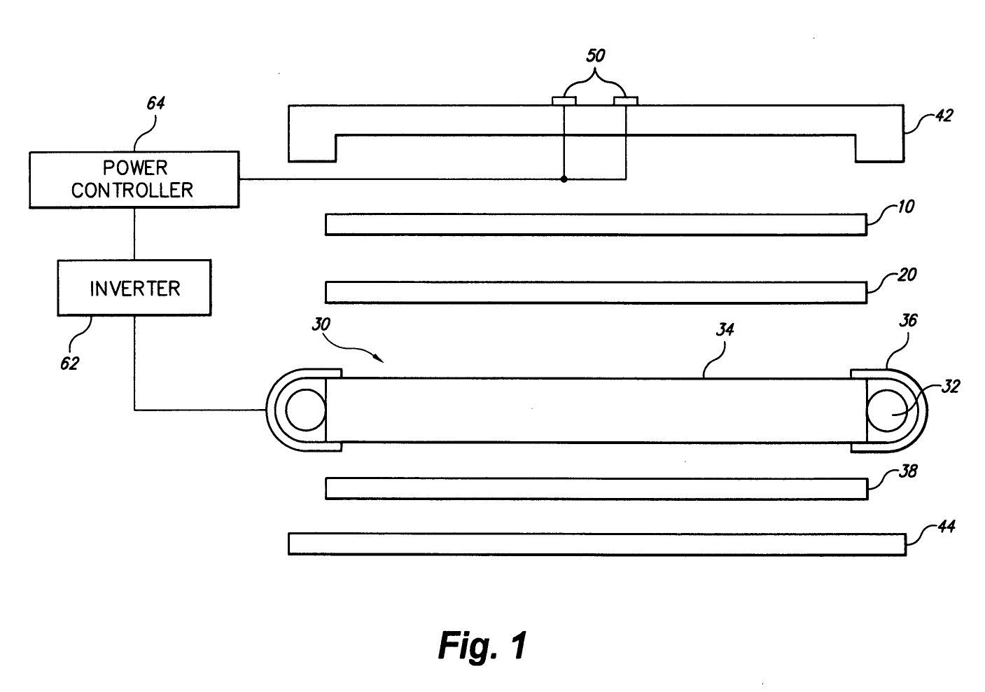

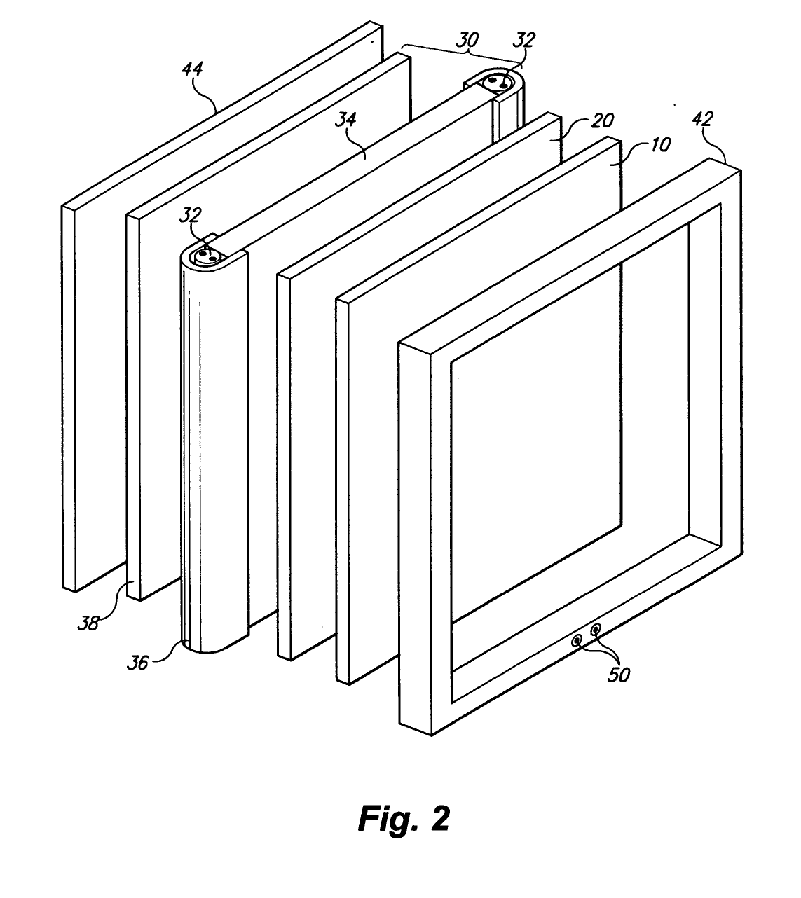

Referring to FIGS. 1 and 2, the advertising apparatus comprises a half-mirror 10, an advertising print 20 located behind the half-mirror 10, a lamp unit 30 located behind the advertising print 20, a front frame 42 and a rear frame 44 enclosing the half-mirror 10 and the lamp unit 30, a sensor 50 attached preferably to the front frame 42 and controlling switching the lamp unit 30 on and off, a power controller 64 supplying electrical power with the lamp unit 30 and the sensor 50, and an inverter 62 supplying the electrical power from the power controller 64 at the desired voltage and frequency required by the lamps.

The half-mirror 10 is a device that reflects images in the manner of an ordinary plane mirror when the area behind the mirror is dark, or when the ratio of ambient light in front of the device to ambient light behind the device exceeds a predetermined ratio, but transmits light emitted by a bright lamp located behind the device like ordinary glass. The half-mirror is sometimes referred to as a transparent mirror, a two-way mirror, or a one-way mirror. Such mirrors are well known in the art, and will not be described further.

The advertising print 20 is a light permeable panel that is located behind the half-mirror 10. The advertising panel 20 has advertising messages, such as characters, paintings or images, imprinted thereon.

The lamp unit 30 is a device that shines a light through the rear of the light permeable panel 20 and the half-mirror 10 in order to take advantage of the half-mirror properties, depending on the environment, as mentioned above. Preferably, the lamp unit 30 employs at least one cold cathode fluorescent lamp (CCFL) as a light-emitting device in order to achieve a thin and compact advertising apparatus. The cold cathode fluorescent lamp operates on substantially the same principles as the well-known hot cathode fluorescent lamp. However, the hot cathode fluorescent lamp switches light on and off by electron emission resulting from thermal treatment (heating a filament to drive electrons through the mercury vapor); the cold cathode fluorescent lamp switches light on and off by electron emission due to a high electrical voltage differential applied to the electrodes. Accordingly, it is possible to manufacture a lamp unit 30 that wastes little energy in the form of heat, and that has a thin, small shape, which is more compact than a hot cathode fluorescent lamp.

The lamp unit 30 preferably comprises one or more cold cathode fluorescent lamps 32, a light guide panel 34 located adjacent to the cold cathode fluorescent lamp 32, a lamp housing 36 attached to at least one edge or side of the light guide panel 34 and that houses the cold cathode fluorescent lamp 32, and a reflector panel 38 located behind the light guide panel 34.

The light guide panel 34 converts light radiated from the cold cathode fluorescent lamp 32 into a planar light source. In order to perform this function, the light guide panel 34 is formed with a plurality of light scattering fragments refracting, diffusing, and adjusting the direction of light scattering through the panel 34.

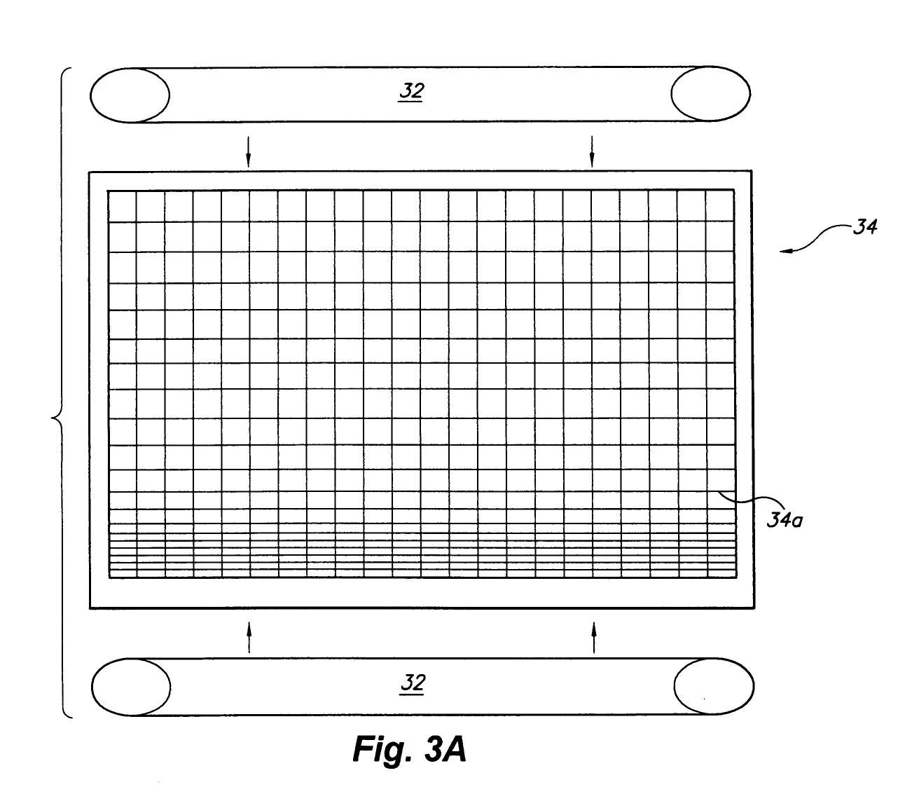

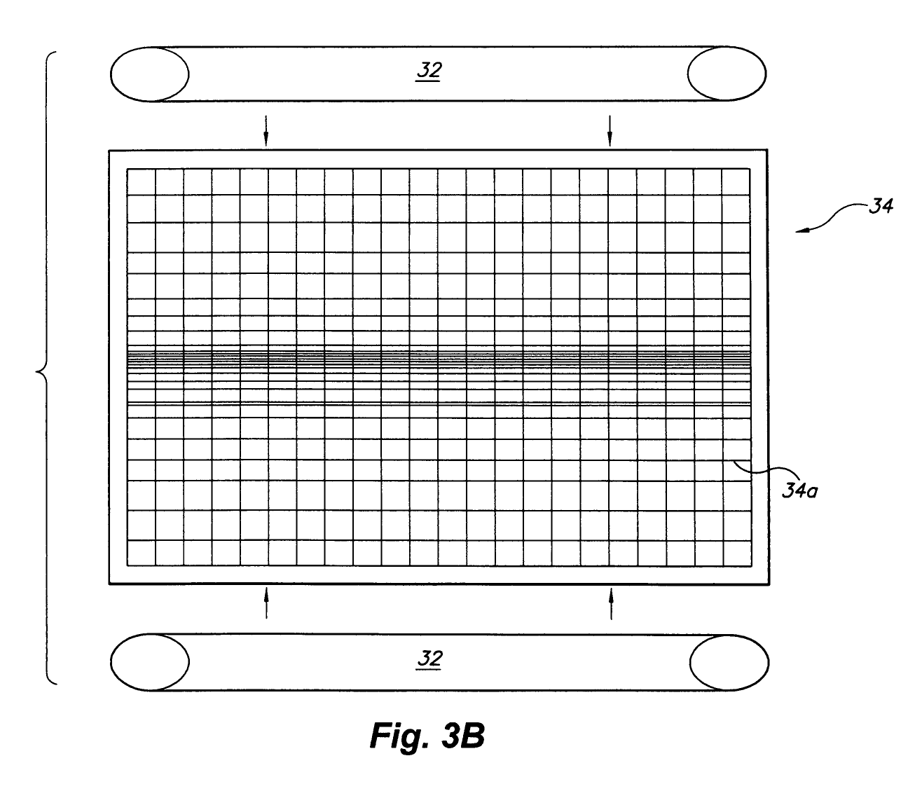

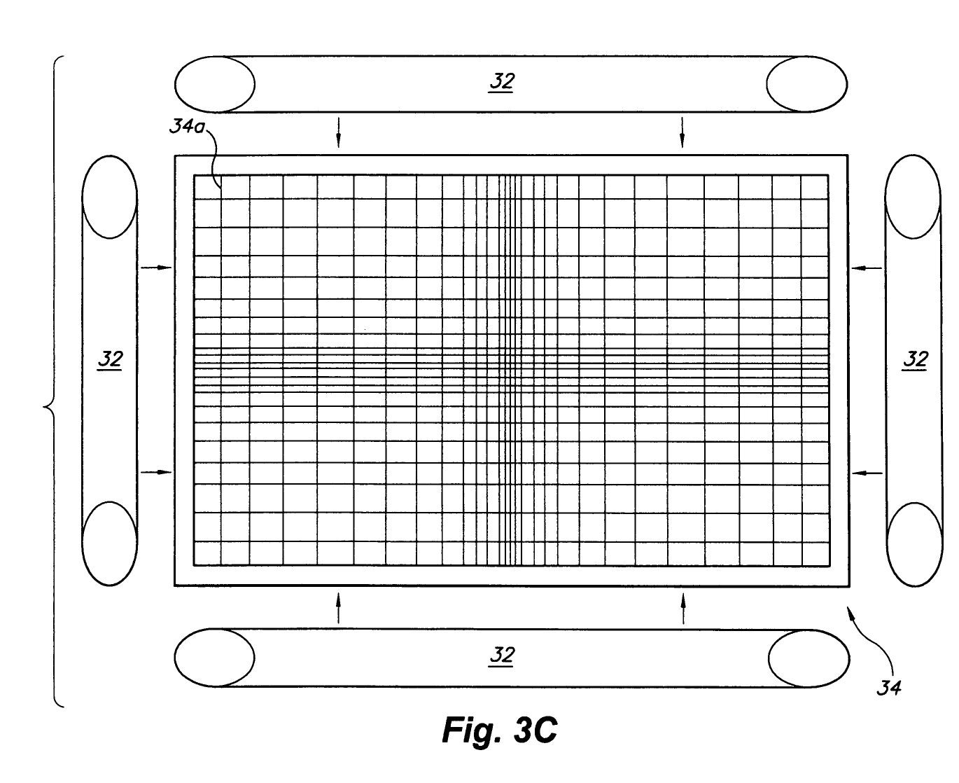

FIGS. 3A to 3C show the density distribution of light scattering fragments in a light guide panel 34 corresponding to the number of lamps 32 in the lamp unit 30. As shown the figures, the density of the scattering fragments 34a is dependent on the number and size of the lamp 32. Preferably, the density of the scattering fragments 34a per unit area increases as the scattering fragments 34a are further away from the lamp 32.

FIG. 3A shows a light guide panel 34 used in conjunction with a single lamp 32 disposed along a top edge of panel 34. Consequently the panel 34 is made with a greater density of scattering fragments 34a (depicted schematically in grid form in the drawing) adjacent the bottom edge of the panel 34. Similarly, FIG. 3B shows a light guide panel 34 used in conjunction with a lamp 32 disposed along both the top edge and the bottom edge of the panel 34, so that the panel 34 is made with a greater density of light scattering fragments 34a across the center of the panel 34. Finally, FIG. 3C shows a light guide panel 34 used in conjunction with a lamp 32 long all four sides or edges of the panel 34, so that the panel 34 is made with a high density of light scattering fragments 34a across the center between the top and bottom edges of the panel 34, and also down the center of the panel between the opposing lateral edges of the panel 34.

The scattering fragments 34a uniformly distribute light, which is incident along the edges or sides of the light guide panel 34, and which is transmitted to the half-mirror 10 located in front of the light guide panel 34, throughout the whole light guide panel 34. Accordingly, the scattering fragments 34a are formed unevenly, that is shaped with prominences and depressions on the surface of the light guide panel 34.

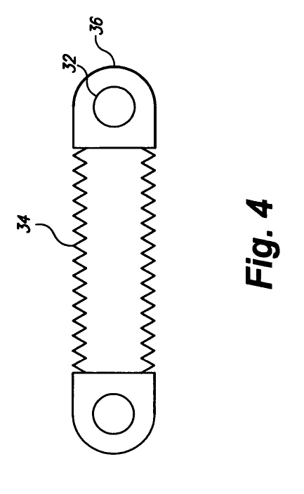

The light guide panel 34 may be made of any desired material. Preferably, the light guide panel 34 is made of a plastic material, such as acrylic. As shown in FIG. 4, the light guide panel 34 may be formed with V-shaped grooves formed in its front and rear surfaces for refracting light incident from the lateral edges of the panel 34 towards the advertising print 20 and half-mirror 10 in front of the panel 34 and towards the reflector panel 38 behind the panel 34. The light guide panel 34 is made with a diffusion material, such as an ink, for forming the scattering fragments for diffusing light through the panel 34, generally with more diffusing ink farther from the lamp 32 than close to the lamp 32, in order to adjust the density of the scattering fragments. However, the light guide panel 34 may be made with the diffusing ink in any desired pattern to adjust the brightness of a certain part of the light guide panel 34, and hence the advertising print 20, as desired. It will also be understood that, although FIG. 4 shows the light guide panel 34 having parallel front and rear surfaces, the panel 34 may have the rear surface at an oblique angle to the front surface, and the reflector panel 38 may be angled parallel to the rear surface, in order to adjust the brightness of the image of the advertising print 20 according to the number of lamps 32.

The lamp housing 36 accommodates the cold cathode fluorescent lamp 32 within it and has a reflector, such as a mirror or reflector panel, formed on the interior thereof in order to direct light radiated form the cold cathode fluorescent lamp 32 in one direction, that is, into the light guide panel 34.

The reflector panel 38 is located behind the light guide panel 34 and directs light through the light guide panel 34 to the front of the advertising apparatus, thereby increasing efficiency of light uses. The reflector panel 38 may be, for example, an ordinary plane mirror with an opaque backing.

The front frame 42 and the rear frame 44 enclose the half-mirror 10, the advertising print 20 and the lamp unit 30, thereby fixing their positions. The frame members, that is, the front frame and the rear frame 44 are joined by bolts or other structural linkages, such as fasteners or friction fit of the frame members 42 and 44.

The front frame 42 serves as a mount for the sensor 50, which senses the approach of persons or objects.

The sensor 50 detects whether persons or objects are approaching the advertising apparatus and switching the lamp(s) 32 on and off accordingly. In order to receive the information, one or more sensors 50 may be mounted in the front frame member 42 and switch the lamp(s) 32 of the lamp unit 30 on in case any person(s) or object(s) approach within a predetermined distance. The sensor 50 may comprise any one of various close-in motion sensors, such as an optical sensor (either visible or infrared), an infrared sensor (such as a temperature or heat sensor), an ultrasonic sensor, etc. Alternatively, the sensor may comprise, e.g., a pressure sensor activated by stepping on a plate in an area in front of the advertising apparatus.

The inverter 62 and the power controller 64 supply electrical power to the lamp unit 30 and the sensor 50. More specifically, the power controller 64 provides electrical power to the sensor 50, and switches power to the lamp unit 30 on and off to convert between a “mirror mode”, which reflects light when power to the lamp unit 30 is switched off, and an “advertising mode”, which displays advertising messages when power to the lamp unit 30 is on, according to the signal from the sensor 50. The inverter 62 converts power applied to the lamp unit 30 from the power controller 64 to alternating current of the voltage and frequency required to turn the cold cathode fluorescent lamp(s) 32 on.

Hereinafter, the operating mechanism of the advertising apparatus according to the present invention will be explained.

The sensor 50, receiving operational electrical power from the power controller 64, senses continuously whether object(s) or person(s) are approaching the advertising apparatus. Initially, the cold cathode fluorescent lamp(s) 32 of the lamp unit 30 is off, and the half-mirror 10 reflects light like a mirror, because light does not shine from the rear.

However, as object(s) or person(s) approach the sensor 50 within predetermined distances, the sensor 50 detects the object(s) or person(s) and transmits the sensing signal to the power controller 64, which is linked to the sensor 50. The power controller 64 responds to the detection signal and directs the inverter 62 to operate.

The inverter 62 supplies electrical power to the lamp unit 30 according to the signal of the sensor 50 and the power controller 64.

In case the cold cathode fluorescent lamp 32 is switched to the on-state by receiving electrical power from the inverter 62, the lamp light is radiated outward of the advertising apparatus through the advertising print 20 and the half-mirror 10. In this case, since the half-mirror 10 has a state of having glass-like permeable properties, the advertising messages printed on the advertising print 20 is shown to person(s) adjacent the advertising apparatus of the present invention.

As person(s) or object(s) move away from the sensor 50, the power controller 64 controls the inverter 62 to cease supplying electrical power to the lamp unit 30, and the half-mirror 10 reverts to the mirror-like state, and the advertising messages are not shown on the advertising apparatus.

Optionally, it is possible to maximize the efficiency of electrical power consumption by incorporating a timer (not shown) that limits the time for supplying electrical power to the cold cathode fluorescent lamp 32 in the on state. Also, a sound storage device (not shown) or a sound transmitting device (not shown), such as a speaker, may be supplied in the advertising apparatus of the present invention to displaying acoustic advertising messages, as well as visual advertising messages.

It is to be understood that the present invention is not limited to the embodiments described above, but encompasses any and all embodiments within the scope of the following claims.

I claim:

1. An advertising apparatus, comprising:
a half-mirror;
an advertising print located behind the half-mirror;
a lamp unit located behind the advertising print;
a frame member enclosing both the half-mirror and the lamp unit;
a sensor located in the frame member and controlling operation of the lamp unit; and
a power supply linked to the lamp unit and the sensor.

2. The advertising apparatus according to claim 1, wherein the advertising print comprises a light permeable panel.

3. The advertising apparatus according to claim 1, wherein the lamp unit comprises:
at least one lamp;
a light guide panel located behind the advertising panel;
a lamp housing connected to one end of the light guide panel and housing the lamp; and
a reflective panel located behind the light guide panel.

4. The advertising apparatus according to claim 3, wherein the at least one lamp comprises a cold cathode fluorescent lamp.

5. The advertising apparatus according to claim 3, wherein the light guide panel has a plurality of light scattering fragments for adjusting light scattering angles in the light guide panel.

6. The advertising apparatus according to claim 3, wherein the reflective panel forms a plane mirror for reflecting light from the lamp.

7. The advertising apparatus according to claim 1, wherein the frame member comprises a front frame and a rear frame attached to each other.

8. The advertising apparatus according to claim 1, wherein the sensor comprises a sensor selected from the group consisting of an optical sensor, an infrared ray sensor, and an ultrasonic sensor.

9. The advertising apparatus according to claim 1, wherein the sensor is located in a front of the frame member.

10. The advertising apparatus according to claim 1, wherein the power supply comprises a power controller supplying electrical power and an inverter electrically connected to the power controller.

11. An advertising apparatus using half-mirror, comprising:
a half-mirror having a front face and a rear face, the half-mirror reflecting light when the rear face is dark and transmitting light when illuminated from the rear face;
a lamp unit disposed behind the half-mirror, the lamp unit having a light guide panel facing the half-mirror, at least one lamp disposed along an edge of the light guide panel, a lamp housing directing illumination from the lamp into the edge of the light guide panel; and a reflector panel disposed behind the light guide panel;
a frame member enclosing the half-mirror and the lamp unit, the frame being adapted for receiving an advertising print between the half-mirror and the lamp unit, the advertising print being a light permeable panel having advertising indicia disposed thereon;
a sensor electrically connected to the lamp unit for detecting a person approaching the frame; and
a power supply electrically connected to the sensor and the at least one lamp, the sensor switching the lamp on when a person approaches the frame in order to display the advertising print, and switching the lamp off when the person moves away from the frame to conserve power.

12. The advertising apparatus according to claim 11, wherein said light guide panel has a plurality of V-shaped grooves defined therein for refracting light from the lamp toward the advertising print and towards the reflector panel.

13. The advertising panel according to claim 11, wherein said light guide panel comprises means for diffusing light from the lamps through said panel with uniform brightness.

14. The advertising panel according to claim 11, wherein said light guide panel comprises a plurality of light scattering fragments disposed therein for diffusing light from the lamps through said panel with uniform brightness.

15. The advertising panel according to claim 14, wherein said scattering fragments are distributed in said light guide panel in increasing density with increasing distance from the edge of said panel adjacent said lamp.

16. The advertising panel according to claim 14, wherein said scattering fragments comprise a diffusion ink incorporated into said light guide panel.

17. The advertising panel according to claim 16, wherein said light guide panel is made from plastic.

18. The advertising panel according to claim 16, wherein said light guide panel is made from acrylic.

19. The advertising panel according to claim 11, wherein said at least one lamp comprises a cold cathode fluorescent lamp.

20. The advertising panel according to claim 11, wherein said reflector panel comprises a plane mirror.
